(19) United States
(12) Patent Application Publication
(10) Pub. No.: US 2021/0344467 A1
(43) Pub. Date: Nov. 4, 2021

(54) Arrangement for Reliable Relaying

(71) Applicant: Nokia Technologies Oy, Espoo (FI)

(72) Inventors: Kari Juhani HOOLI, Oulu (FI); Esa Tapani TIIROLA, Kempele (FI); Timo Erkki LUNTTILA, Espoo (FI); Klaus HUGL, Wien (AT)

(21) Appl. No.: 17/272,975

(22) PCT Filed: Sep. 4, 2018
(86) PCT No.: PCT/EP2018/073753

§ 371 Date: Mar. 3, 2021

(51) Int. Cl. H04L 5/00; H04W 76/14; H04W 72/08; H04W 72/04

(52) U.S. Cl. CPC H04L 5/0044; H04L 5/0037; H04L 1/0003; H04W 72/085; H04W 72/0413; H04W 76/14

(57) ABSTRACT

According to an aspect, there is provided an access node for configuring relaying using one or more terminal devices. The access node is configured to select the one or more terminal devices connected to the access node for relaying a signal from the source terminal device to the access node based on radio link measurements. Further, the access node is configured to configure each of the one or more terminal devices to decode each received primary uplink resource and if the decoding is successful, to cause transmitting a transport block corresponding to the decoded primary uplink resource on a secondary uplink resource using a pre-defined starting position to a target network node. The access node is also configured to receive at least one transport block transmitted from the source terminal device via one or more terminal devices on one or more secondary uplink resources.

### TECHNICAL FIELD

Various example embodiments relates to wireless communications.

### BACKGROUND

Factory floor presents a challenging radio propagation environment for ultra-reliable low latency communication (URLLC) often required for industrial automation scenarios. For example, the machinery in the factory may cause interference while bulky metallic structures and objects prevalent in many factories may cause blockage or at least significant attenuation. As a result of these effects, the signal detection rate may not be sufficient for URLLC unless steps are taken to over-come or alleviate at least some of the aforementioned problems.

### BRIEF DESCRIPTION

According to an aspect, there is provided the subject matter of the independent claims. Embodiments are defined in the dependent claims.

One or more examples of implementations are set forth in more detail in the accompanying drawings and the description below. Other features will be apparent from the description and drawings, and from the claims.

### BRIEF DESCRIPTION OF DRAWINGS

In the following, example embodiments will be described in greater detail with reference to the attached drawings, in which

FIGS. 1 and 2 illustrate exemplified wireless communication systems;

FIGS. 3 to 10, 11A, 11B, 11C, 12A, 12B and 12C illustrate exemplary processes according to embodiments; and

FIGS. 13 and 14 illustrate apparatuses according to embodiments.

### DETAILED DESCRIPTION OF SOME EMBODIMENTS

The following embodiments are only presented as examples. Although the specification may refer to “an”, “one”, or “some” embodiment(s) and/or example(s) in several locations of the text, this does not necessarily mean that each reference is made to the same embodiment(s) or example(s), or that a particular feature only applies to a single embodiment and/or example. Single features of different embodiments and/or examples may also be combined to provide other embodiments and/or examples.

Embodiments and examples described herein may be implemented in any communications system comprising wireless connection(s). In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. It is obvious for a person skilled in the art that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), beyond 5G, wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

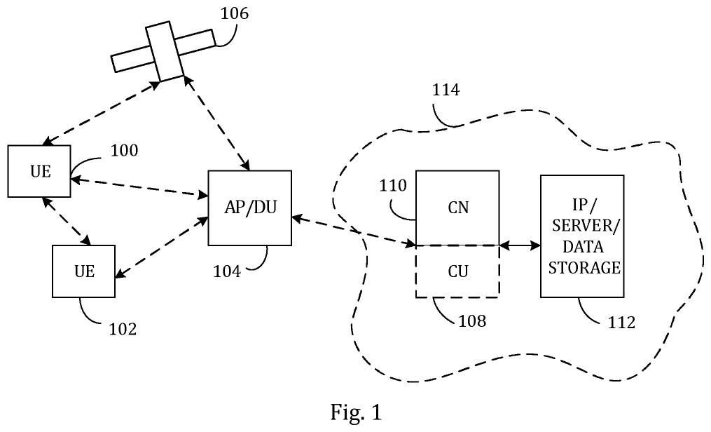

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a cell with an access node (such as (e/g)NodeB) 104 providing the cell. The physical link from a user device to a (e/g)NodeB is called uplink or reverse link and the physical link from the (e/g)NodeB to the user device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used for signalling purposes. The (e/g)NodeB is a computing device configured to control the radio resources of communication system it is coupled to. The NodeB may also be referred to as a base station, an access point or any other type of interfacing device. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 110 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 2 relay or a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

It should be understood that, in FIG. 1, user devices are depicted to include 2 antennas only for the sake of clarity. The number of reception and/or transmission antennas may naturally vary according to a current implementation.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications such as (massive) machine-type communications (mMTC), including vehicular safety, different sensors and real-time control. 5G is expected to have multiple radio interfaces, namely below 6 GHz, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 104) and non-real time functions being carried out in a centralized manner (in a centralized unit, CU 108).

It should also be understood that the distribution of labor between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (loT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano)satellites are deployed). Each satellite 106 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may comprise also other apparatuses, such as physical layer relay nodes or other network elements, etc. At least one of the (e/g)NodeBs or may be a Home (e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network. As mentioned above, one suggested feature of the future 5G communications systems is the so-called 5G New Radio. 5G New Radio refers to a new global 5G standard for an orthogonal frequency-division multiplexing (OFDM)-based air interface designed to fit the more stringent requirements of the 5G systems (for example, providing different types of services to a huge number of different types of devices operating over a wide frequency spectrum). The 5G New Radio shall be able to allow network deployment with minimized manual efforts and as automated self-configuration as possible. Especially on higher frequency bands the coverage will be an issue and specific capabilities are needed for New Radio to enable easy coverage extension with minimized/none requirements for network (re-)planning in a fast and cost-efficient manner.

One of the features supported by 5G New Radio is the use of configured grant Physical Uplink Shared Channel (PUSCH) resources. According to NR, the gNB (i.e., the access node) can dynamically allocate resources, in the uplink, to UEs (i.e., terminal devices) using the Cell Radio Network Temporary Identifier (C-RNTI) on Physical Downlink Control Channel(s) (PDCCH(s)). C-RNTI is a unique identifier used for identifying RRC connection and scheduling dedicated to a particular UE. A UE always monitors the PDCCH(s) in order to find possible grants for uplink transmission when its downlink reception is enabled. In addition, with Configured Grants, the gNB is able to (semi-statically) allocate uplink resources for the initial hybrid automatic repeat request (HARQ) transmissions to UEs. Two types of configured uplink grants are defined. With Type 1 configured grant, Radio Resource Control (RRC) directly provides the configured uplink grant (including the periodicity). With Type 2 configured grant, RRC defines the periodicity of the configured uplink grant while PDCCH addressed to Configured Scheduling RNTI (CS-RNTI) can either signal and activate the configured uplink grant, or de-activate it. In other words, a PDCCH addressed to CS-RNTI uplink grant can be implicitly reused according to the periodicity defined by RRC, until deactivated.

When a configured uplink grant is active, if the UE cannot find a dynamic uplink (UL) grant using C-RNTI/CS-RNTI on the PDCCH(s), an uplink transmission according to the configured uplink grant can be made. Otherwise, if the UE finds a dynamic UL grant using C-RNTI/CS-RNTI on the PDCCH(s), the PDCCH allocation overrides the configured uplink grant. Retransmissions other than repetitions are explicitly allocated via PDCCH(s).

It should be noted that a similar mechanism as described in the previous paragraph for 5G NR is also supported in LTE. In LTE, a similar mechanism for licensed bands is UL semi-persistent scheduling (SPS). Moreover, the mechanism which provides autonomous UL transmissions on unlicensed spectrum (SCells in Licensed Assisted Access) is called Autonomous UL Access (AUL) and has the following properties:
A UE can be RRC configured with a set of subframes and HARQ processes that it may use for autonomous PUSCH transmissions.
AUL operation is activated and released with Downlink Control Indicator (DCI) format 0A or 4A.
A UE skips and AUL allocation if there is no data in UL buffers.
Physical Resource Block (PRB) allocation, Modulation Coding Scheme (MCS), as well as Demodulation Reference Signal (DMRS) cyclic shift and orthogonal cover code are indicated to the UE with AUL activation DCI.
The UE indicates to the eNodeB along with each UL transmission the selected HARQ-process ID, new data indicator, redundancy version, UE ID, PUSCH starting and ending positions, as well as whether the UE-acquired channel occupancy time (COT) can be shared with the eNodeB.
The eNodeB may provide to the UE HARQ feedback for AUL-enabled HARQ processes, transmit power command, and transmit PMI.

AUL also allows for configuring a set of starting positions for UEs with a very fine raster within the first SC-FDMA symbol of a subframe: 16, 25, 34, 43, 52, or 61 microseconds after the subframe boundary, or at the beginning of symbol #1. Since all UEs perform Listen-Before-Talk (LBT) operation prior to the AUL transmission to determine whether the channel is free, different starting point allow for, e.g., prioritizing transmissions for certain UEs (by assigning an earlier starting point) and reducing the number of collisions.

Further, MulteFire 1.1 also supports grant-free UL (GUL). The solution is similar to the AUL described above.

The embodiments to be described below utilize a configured (uplink) grant scheme (as described above) for overcoming or alleviating problems encountered especially when using Ultra-Reliable Low Latency Communication (URLLC) in certain demanding radio propagation environment. One such demanding radio propagation environment is a factory floor. Many industrial automation systems employ currently or are envisioned to employ in the future wireless communications for control and/or other functions. Considering the high precision work performed, for example, by industrial robotics system for laser welding or cutting, low latency and high reliability are of high importance.

Multiple challenges in view of radio propagation persist in a factory floor environment. Firstly, machinery on the factory floor may cause interference. Secondly, multiple bulky metallic structures and objects, some of which may even be non-stationary, may be located on the factory floor causing blockages and/or significant attenuation (i.e., large-scale fading). Thirdly, collisions of the grant-free transmissions as well as interference from other cells/transmissions further deteriorate the performance of the communications links. All of the aforementioned factors contribute to the deterioration of the signal detection rate which may easily fall below what is an acceptable level for URLLC.

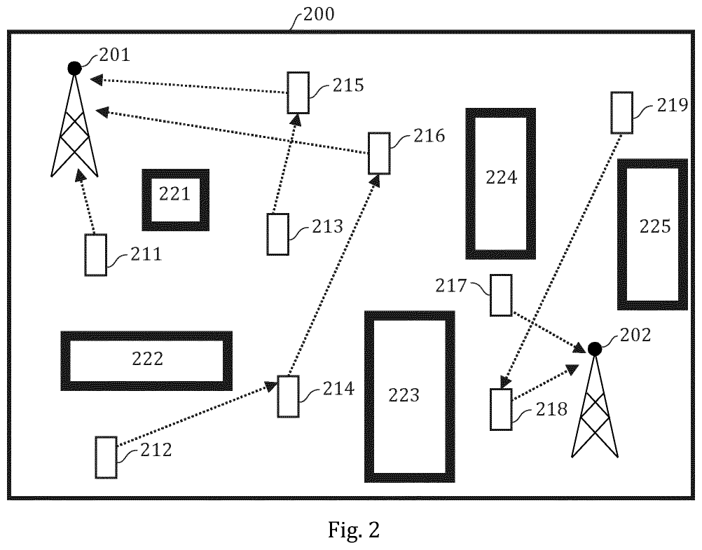

FIG. 2 illustrates another example of a communications system 200 to which some embodiments may be applied. The communications system 200 may be a wireless communication system inside a large building. Specifically, said large building may be a factory floor or some other industrial facility, for example, a warehouse. The wireless communication system 200 may also be on an industrial area or on an area used for freight transport such as harbor, railway yard or yard for shipping containers. Such industrial facilities, yards, or areas are quite controlled environments which means that, e.g., WiFi transmissions may be expected to be infrequent and accidental. Also, propagation delays may expected to be relatively short (i.e., not several kilometers).

The communications system 200 comprises one or more access nodes 201, 202 each of which may correspond to element 104 of FIG. 1. Each access node may provide and control a respective cell or cells (not shown in FIG. 2 for simplicity and clarity). From another point of view, each cell may define a coverage area or a service area of the access node. The cells may comprise, for example, one or more small cells (micro, femto and/or pico cells) and/or one or more macro cells.

The access nodes 201, 202 may be connected via radio (access) links to one or more terminal devices 211, 212, 213, 214, 215, 216, 217, 218, 219. This link is called an access link. Each terminal device 290 may correspond to either of elements 100, 103. Thus, the access nodes may provide one or more terminal devices (user equipment, UEs) with wireless access to other networks such as the Internet, either directly or via a core network. Said wireless access may be provided directly (using a single “hop”) or via multiple “hops” where one or more terminal devices 211, 212, 213, 214, 215, 216, 217, 218, 219 act as relay nodes.

In embodiments where the communications system 200 corresponds to an industrial facility, the terminal devices may be any industrial equipment capable of connecting to a wireless network. Thus, the one or more terminal devices 211, 212, 213, 214, 215, 216, 217, 218, 219 (or at least some of them) may not have any strict battery constraints and they may be static or moving at a moderate velocity (e.g., a forklift). Further, at least some of the terminal devices may be configured to communicate not only with the access nodes 201, 202 but also between with each other (e.g., communication between a control unit and a “functional” unit such as a welding unit).

The radio propagation environment of the communication system 200 comprises one or more obstacles 221, 222, 223, 224, 225. Said one or more obstacles 221, 222, 223, 224, 225 when located between transmitting and receiving network nodes (i.e., terminal devices or access nodes) may cause large-scale fading effects (blockage or shadowing) which deteriorate the signal quality of the corresponding link. The line-of-sight path may, in some cases, be fully blocked by an obstacle. Further, the one or more obstacles may cause unwanted reflections.

The shape and type of the one or more obstacles may vary. Said one or more obstacles may comprise, for example, large industrial machinery, assembly line structures, metal barriers or walls, metallic scaffolding, stored raw materials, products or shipping containers. Moreover, said one or more obstacles may comprise one or more moving obstacles such as forklifts and other vehicles.

FIG. 2 also illustrates optimal uplink connections (e.g, in terms of signal or link quality) for the one or more terminal devices 211, 212, 213, 214, 215, 216, 217, 218, 219. While some of the terminal devices 211, 215, 216, 217, 218 are able to connect directly to one of the access nodes 201, 202, other terminal devices 212, 213, 214, 219 require two or more “hops” (i.e., communicating a packet by two or more sequential transmissions) due to, for example, the line-of-sight path to the access node 201, 202 being blocked by an obstacle or interference caused by a local signal source. For the latter set of terminal devices, one or more other terminal devices in the communications system act as relay nodes according to embodiments to be discussed below.

While only a single (best) connection option is shown for each terminal device 211, 212, 213, 214, 215, 216, 217, 218, 219 in FIG. 2, it should be appreciated that more than one path may be available at least for some of the terminal devices at any one time for connecting to the access node(s) 201, 202.

The timely delivery of single packet on a multi-hop approach in a radio propagation environment as depicted in FIG. 2 is vulnerable to detection failure in any of the hops. Detection failure may be used to trigger retransmissions, but this will, in turn, increase latency. One solution for the said vulnerability problem is creating multiple parallel and cooperative relay paths providing also diversity against large-scale fading. The embodiments to be discussed below provide implementations of said solution which may be built on top of existing (NR) signal processing functionalities and maintains good efficiency in terms of resources.

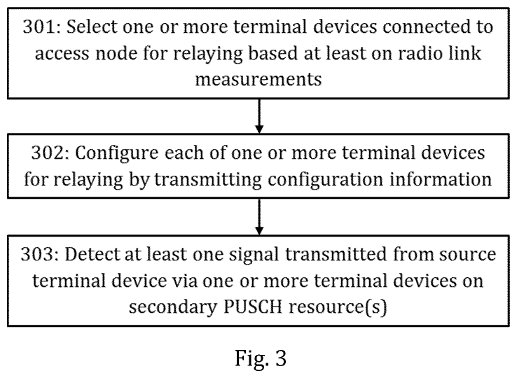

FIG. 3 illustrates a process according to an embodiment for configuring one or more terminal devices to perform relaying so that high reliability with low latency may be achieved. The illustrated process may be performed by an access node or specifically the access node 104 of FIG. 1 or the access node 201 or 202 of FIG. 2. While the process is discussed in the following in terms of an access node carrying out the process, in other embodiments another network node (possibly in communication with an access node) may carry out the illustrated process.

The process of FIG. 3 may be initiated when the access node fails to detect a signal from a source terminal device. The access node may have been in communication with the source terminal device for a certain amount time without issues before the signal quality decreases (due to e.g., interference) below acceptable level. In other words, the process may be triggered by a metric indicating signal or link quality or signal detection rate decreasing below a pre-defined level. Alternatively, or additionally, the process of FIG. 3 may be initiated when a logical connection requiring low latency with high or ultra-high reliability is configured for the source terminal device. Alternatively, the process of FIG. 3 may be initiated when a logical connection requiring low latency with high or ultra-high reliability is configured for the source terminal device and a signal from a source terminal device is below a pre-defined threshold. In other words, the energy of received signal may be below a threshold that is for example configured to the access node in the commissioning of the access node or by the network maintenance. The signal may for example be a reference signal such as sounding reference signal or demodulation reference signal, or a random access preamble.

Referring to FIG. 3, the access node selects, in block 301, one or more terminal devices connected to the access node for relaying a signal (or a transport block) from the source terminal device to the access node based at least on radio link measurements (or channel measurements), e.g., between terminal devices and/or terminal devices and the access node. The selecting may be further based on the capability and/or class of the one or more terminal devices. The one or more terminal devices may correspond to one or more terminal devices 211, 212, 213, 214, 215, 216, 217, 218, 219 of FIG. 2. The selecting may be made from a plurality of terminal devices capable of connecting to the access node and which the access node has discovered.

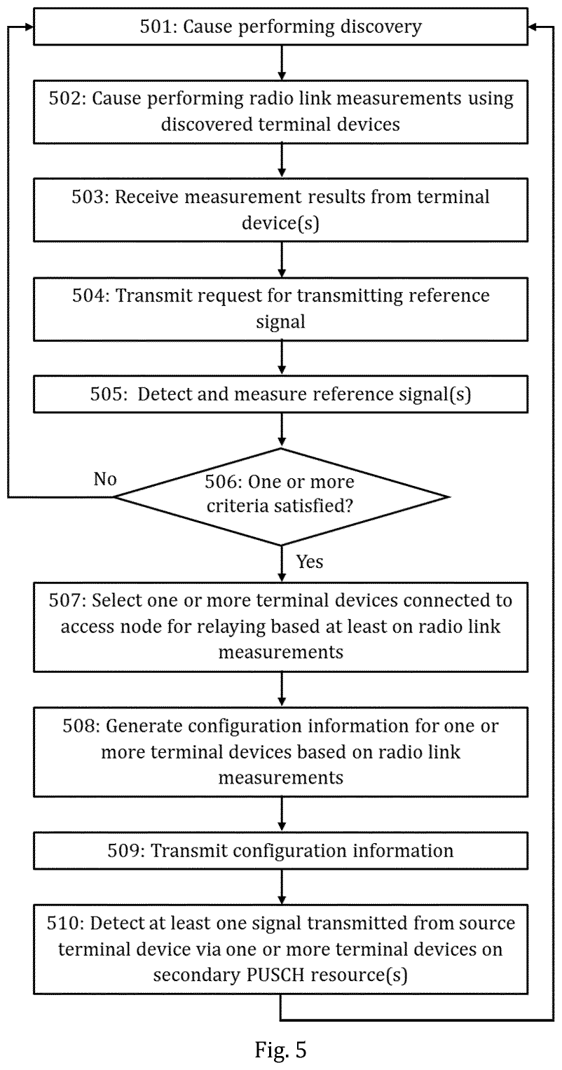

Information on radio link measurements between terminal devices and between the access node and the terminal devices may be maintained in a database comprised in or connected to the access node. The terminal devices may be configured to report radio link measurements periodically to the access node and/or the access node may request the terminal devices to perform radio link measurements (as will be discussed in more detail in relation to FIG. 5). The access node may select, for example, a pre-defined number of terminal devices having the highest values of a metric indicating link quality. The radio link in question may be a radio link from the source terminal device to the access node via the terminal device, a radio link between the terminal device and the access node or a radio link between the terminal device and the source terminal device. Alternatively, the access node may select the one or more terminal devices to comprise all the terminal devices for which said metric indicating radio link quality exceeds a pre-defined threshold.

After the selection has been made, the access node configures, in block 302, each of the one or more terminal devices by generating configuration information and transmitting the configuration information to them. The configuration (information) may be defined differently for different terminal devices based on, for example, radio link qualities defined in the radio link measurements. The configuration information may comprise at least Modulation Coding Scheme (MCS), PRB allocation and Radio Network Temporary Identifier (RNTI) used by the source terminal device. In an embodiment, the configuration information comprises one or more of information on the primary PUSCH resources to be used in decoding, information on secondary PUSCH resources to be used in transmitting, a MCS, a PRB allocation, a first RNTI used by the source terminal device and a second RNTI to be used by the configured terminal device (which may or may not be equal to the RNTI used by the source terminal device).

Specifically, the access node may configure each terminal device of the one or more terminal devices at least to decode (blindly) any received primary (1^{st}) PUSCH resources (i.e., to decode transport blocks on the primary PUSCH resources). The information on the primary PUSCH resource configuration (i.e., information on which PUSCH resources to decode) may be included in the transmitted configuration information. The RNTI used by the source terminal device and comprised in the configuration information may be used in the decoding. The primary PUSCH resources may be primary Configured Grant, CG, PUSCH resources or dynamically scheduled PUSCH resources. In the latter case, the terminal device may be provided in the configuration information the related RNTI and the Physical Downlink Control Channel, PDCCH, monitoring configuration of the source terminal device. Further, if the decoding is successful, each terminal device may be configured to transmit a transport block corresponding to the decoded primary PUSCH resource on a secondary (2^{nd}) PUSCH resource to a target network node. Further, each terminal device may be configured, using the configuration information, to transmit the transport block using a pre-defined starting position (i.e., to initiate the transmission at different pre-defined time instances). The starting position may be defined here and in the following as a starting position for transmission in time relative to the slot boundary or starting time of the associated slot. The access node may configure the one or more terminal devices so that the secondary (2^{nd}) PUSCH resource and the pre-defined starting position are different for each of the one or more terminal devices. The pre-defined starting position for each terminal device may be determined based, e.g., on the radio link measurements or more specifically on values of a pre-defined metric indicating link quality towards the target network node (calculated based on the radio link measurements). The secondary PUSCH resource may be a secondary CG PUSCH resource (different from the primary CG PUSCH resource). The target network node may be the access node or one of the one or more terminal devices (which is, in turn, configured to relay the transport block to the access node, possible via one or more terminal devices). At least one terminal device may be configured by the access node to use the access node itself as the target network node.

The access node receives or detects, in block 303, at least one transport block transmitted from the source terminal device via one or more terminal devices of the one or more terminal devices on one or more secondary PUSCH resources (i.e., secondary PUSCH resources assigned for the corresponding terminal devices). Obviously, the access node may also still detect the original transport block transmitted by the source terminal device on the primary PUSCH resource without relaying.

While in some embodiments, all the terminal devices may be configured to perform relaying with two hops (i.e., transmission from source terminal device to the relaying terminal device and from the relaying terminal device to the access node), in other embodiments three or more hops may be defined for at least some relaying links. For the two-hop relaying, the primary PUSCH resource may be the same primary PUSCH resource used by the source terminal device for all configured terminal devices while the secondary PUSCH resource may be different for at least some of the configured terminal devices. In the cases where three or more hops are used for at least some relaying links, the primary PUSCH resource may be a PUSCH resource used by the source terminal device or a preceding terminal device in the relay chain for transmission and the secondary PUSCH resource may be a PUSCH resource used by the access node or a subsequent terminal device in the relay chain for reception.

In some embodiments, the access node may configure, in block 302, each of the one or more terminal devices with the configuration information to perform the decoding only for Ultra-Reliable Low Latency Communication, URLLC, transmissions. In some such embodiments, different source terminal devices may use different primary (CG) PUSCH resources while different links (i.e., sidelinks/uplinks) from the same source terminal, which may be separated based on used RNTI, may use the same secondary (CG) PUSCH resource. Alternatively or in addition, the access node may configure, in block 302, each of the one or more terminal devices with the configuration information to perform the decoding only for transmissions originating from the source terminal device based on the decoded primary PUSCH resources and/or a first Radio Network Temporary Identifier, RNTI, used in the decoding.

In some embodiments, the one or more terminal devices may be configured, in block 302, by the access node using the configuration information to use in the transmitted transport block on the secondary PUSCH resource the same RNTI which is used also by the source terminal device on the primary PUSCH resource. By using the same RNTI in the repeated transmission, the target network node is easily able to identify the source terminal device (even in the case that multiple source terminal devices use the same PUSCH resource in transmission) and/or the target terminal device (in the case of sidelink and uplink from the same terminal device). In such embodiments and in embodiments where multiple hops are employed, the original transmission and the hops need to be separated by using different PUSCH resources to prevent the relaying of already relayed information on a parallel hopping-link path. The PUSCH resources may be different in frequency and/or in time so that the original transmission and each of the hops use different resources for transmission of current transport block and for possible consecutive transport block(s).

In an alternative solution to the embodiment described in the previous paragraph, the one or more terminal devices for relaying/repeating may use a second RNTI that is configured to be used solely for repeating/relaying the transmission from the source terminal device. Said second RNTI may be specific to each particular repeated/relayed link as well as to the hop order (i.e., 1^{st} hop, 2^{nd} hop, 3^{rd} hop etc.) in case of multiple hops.

In yet another alternative embodiment, each of the multi-hop transmissions may further include some related control information, e.g., defining the source, time instant, hopping-link-path identification and/or hop number (within the hopping-link-path). Such relaying related information may be carried as Uplink Control Information (UCI) mapped together with the relayed (re-)transmission. Such information may be used to identify and coordinate the transmission of multiple hopping links, e.g., preventing the relaying of already relayed information on a parallel hopping-link path.

In some embodiments, each terminal device may be involved in repeating/relaying signals for multiple links (i.e., for multiple source terminal devices and/or multiple access nodes). The terminal devices may be configured to separate links originating from different source terminal devices as well as links originating from the same source terminal device but for different target network nodes (e.g., sidelink and uplink) based on different (secondary) PUSCH resource and/or different RNTIs. Optionally, one or more of DMRS, MCS and PRB allocation may also be used for the separating.

It should be noted that the embodiments may primarily seek to increase reliability with short latency, not cell coverage extension. Hence, normal transmission may use C-RNTI which does not trigger the relaying while specific RNTI may be used for transmissions requiring or benefiting from the relaying. For example, data that is sensitive from security viewpoint may use normal transmission.

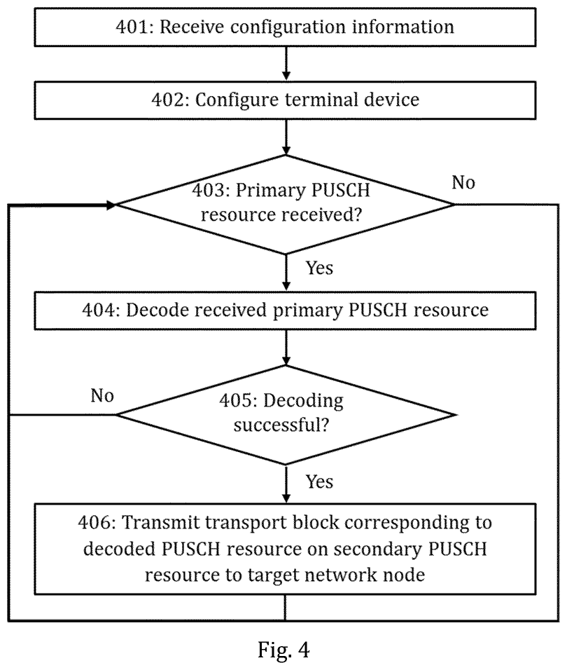

FIG. 4 illustrates a process according to an embodiment for performing the relaying by a terminal device. The illustrated process may be performed by any of the terminal devices 100, 102 of FIG. 1 or 211, 212, 213, 214, 215, 216, 217, 218, 219 of FIG. 2. The illustrated process may correspond to the process carried out by each terminal device after receiving configuration information from an access node as described in relation to FIG. 3.

Referring to FIG. 4, the terminal device initially receives, in block 401, the configuration information from an access node. Specifically, the configuration information may be configuration information enabling relaying packets from a particular source terminal device to a target network node. The configuration information may be defined as described in relation to FIG. 3 or as will be described in relation to further embodiments. In response to receiving the configuration information, the terminal device configures, in block 402, itself based on the configuration information. Configuration may be performed, e.g., by means of RRC signaling. After the configuration, the terminal device may transmit, in some embodiments, an acknowledgment or a confirmation to the access node which transmitted the configuration information.

After the terminal device has been configured, the terminal device acts according to its configuration by performing the following. In response to receiving, in block 403, a primary PUSCH resource (as defined in the configuration information), the terminal device decodes (or tries to decode), in block 404, the primary PUSCH resource. The decoding may be based on information on the packets transmitted by the source terminal device comprised in the configuration information (e.g., RNTI, MCS, PRB allocation). In response to the decoding being successful in block 405, the terminal device causes transmitting, in block 406, a transport block corresponding to the decoded primary PUSCH resource on a secondary PUSCH resource (as defined in the configuration information) to the target network node (i.e., another terminal device or the access node). If the decoding is determined to be unsuccessful in block 405, the terminal device may simply ignore the received primary PUSCH resource and wait for further transmissions of the primary PUSCH resource (i.e., process may proceed to block 403). As multiple terminal devices may have been configured to relay packets from the source terminal device as described in relation to FIG. 3, the transport block may be transmitted on the secondary PUSCH resource (or another PUSCH resource) by another terminal device in such a case.

The terminal device may be assumed, in most embodiments, to operate according to half-duplex constraint, i.e., it is not capable of transmitting and receiving at the same time on the same uplink band. If the terminal device has a valid uplink grant for the time defined for primary PUSCH reception and detection, the terminal device may be configured to prioritize PUSCH transmission.

FIG. 5 illustrates an alternative process according to an embodiment for configuring one or more terminal devices to perform relaying. The illustrated process may be performed by an access node or specifically the access node 104 of FIG. 1 or the access node 201 or 202 of FIG. 2.

In FIG. 5, the actions relating to radio link measurements are described in more detail according to an exemplary embodiment. Initially, the access node causes, in block 501, performing discovery on one or more terminal devices. In other words, the access node requests one or more terminal devices to discover other terminals by detecting a discovery signal. After the one or more terminal devices have performed the discovery, they transmit (as requested by the access node) the discovery results (e.g., identifiers or indexes for the detected discovery signals) to the access node. The access node causes, in block 502, performing radio link (or channel) measurements on one or more discovered terminal device to terminal device links. In other words, the access node requests one or more terminal devices of the one or more discovered terminal device to terminal device links to perform radio link measurements for the discovered terminal device to terminal device links. After the one or more terminal devices have performed the radio link measurements, they transmit (as requested by the access node) the measurement results (e.g., a metric indicating link quality) to the access node. Consequently, the access node receives, in block 503, the measurement results of the radio link measurements from the one or more terminal devices.

In addition to measuring terminal device to terminal device links, the access node may also measure the uplink channels (i.e., their link quality) for the same terminal devices. To this end, the access node causes transmitting, in block 504, to the one or more terminal devices a request for transmitting a reference signal to the access node. The one or more terminal may be the one or more terminal discovered in block 501. Subsequently, the access node detects and measures, in block 505, one or more reference signals transmitted from the one or more discovered terminal devices.

Some or all of the actions performed in block 501 to 505 may be repeated periodically. As in a factory floor scenario as described above many of the terminal devices are static, said actions may be repeated relatively infrequently in such a scenario. The acquired up-to-date measurement results (relating both to terminal device to terminal device links as well as to uplinks) may be stored to a memory or a database. This may be carried out by a logical entity called topology manager. In some embodiments, only one of the two processes relating to blocks 502, 503 and blocks 504, 505 may be carried out.

The access node determines, in block 506, whether one or more criteria for triggering or initiating the relaying is satisfied. The criteria may be any criteria for initiating the selecting as described in relation to FIG. 3. Specifically, the criteria may be that a signal from a source terminal device is not detected (no longer detected) by the access node and/or that the source terminal device is configured for transmission with low latency and high or ultra-high reliability.

The actions performed in block 507 may correspond to the actions described in relation block 302 of FIG. 3. The selecting of the one or more terminal devices, in block 507, may be based on the measurement results and/or one or more measured reference signals acquired in blocks 501 to 505.

The step of configuring of the one or more terminal devices (i.e., block 302 of FIG. 3) has been divided in the embodiment of FIG. 5 into two distinct phases. First, the access node generates, in block 508, configuration information for the one or more terminal devices based at least on the radio link measurements (i.e., the measurement results of the radio link measurements) and consequently causes transmitting, in block 509, the configuration information to the one or more terminal devices. The configuration information may be generated so as to configure the one or more terminal devices as discussed in relation to embodiments illustrated in FIGS. 3 and 4. Specifically, the configuration may be such that the primary PUSCH resources (associated with packets/TBs received from the source terminal device) are primary CG PUSCH resources and the secondary PUSCH resources (associated with packets/TBs transmitted to the target network node) are secondary CG PUSCH resources. Multiple secondary CG PUSCH resources may be configured to each of the one or more terminal devices. Additionally, the first and secondary CG PUSCH resources for each terminal device of the one or more terminal devices may be defined in the configuration information to be connected via a one-to-one mapping in time. In other words, each primary CG PUSCH maps to at least one secondary CG PUSCH resource. This mapping may be different for different terminal devices of the one or more terminal devices. The one-to-one-mapping may correspond, for example, to a pre-defined time off-set. The pre-defined time offset may be defined, e.g., as multiples of a slot. In addition to the pre-defined time offset, the one or more terminal devices may be configured to initiate transmission at different starting positions (i.e., at different time instances) based on the radio link measurements.

The measurement results of the radio link measurements acquired in blocks 501 to 505 may be employed in configuring the one or more terminal devices using the aforementioned pre-defined starting positions in the following way. Using the measurement results, the one or more terminal devices may be, first, arranged based on values of a pre-defined metric indicating link quality towards the target network node. Specifically, the pre-defined metric may indicate radio link quality between the terminal device and the target network node or link quality between the source terminal device and the target network node via at least the terminal device in question. A certain number of values of the pre-defined secondary PUSCH starting positions may be pre-defined. The pre-defined starting positions may be, for example, relative to the slot boundary or to the start of the slot and may be defined in multiples of a symbol or in fractions of a symbol. The symbol may be, for example, a CP-OFDMA or a DFT-S-OFDMA symbol. The starting positions may be confined within a single slot. The smallest pre-defined value of the pre-defined starting position (i.e., a first or earliest starting position) may be assigned to the terminal device with the highest link quality, the second smallest pre-defined value of the pre-defined starting position (i.e., a second or second earliest starting position) may be assigned to the terminal device with the second highest link quality and so on until all the terminal devices have been assigned a pre-defined starting position for the relaying using a secondary CG PUSCH resource. The pre-defined starting position assigned for a terminal device may be, for example, inversely proportional to the metric indicating link quality towards the target network node or defined via a monotonically decreasing function of the metric indicating link quality or based on the order of values of the pre-defined metric indicating link quality for the one or more terminal devices (selected in block 507) so that the highest value of the pre-defined metric corresponds to a first (i.e., earliest) starting position and the lowest value of the pre-defined metric corresponds to a last starting position.

In some embodiments, the access node may also cause transmitting, in block 509, (source) configuration information to the source terminal device (in addition to transmitting configuration information to the one or more terminal devices to be used for relaying as discussed above). Specifically, the access node may configure the source terminal device, by transmitting at least the first RNTI to the source terminal device, to use the first RNTI for transmitting on the primary PUSCH resource. The first RNTI may be a RNTI used by the source terminal device only for relaying transmissions. During normal (non-relaying) operation, the source terminal device may be configured (by default) to use a C-RNTI for transmissions.

The actions performed in block 510 may correspond to the actions described in relation block 303 of FIG. 3.

In some embodiments, MCS for the one or more terminal devices may be configured by the access node using the configuration information separately for each relaying terminal device with different starting position.

In some embodiments, the measurement results used for determining the pre-defined starting positions for the one or more terminal devices may be measurement results available at the time of Radio Resource Control (RRC) configuration.

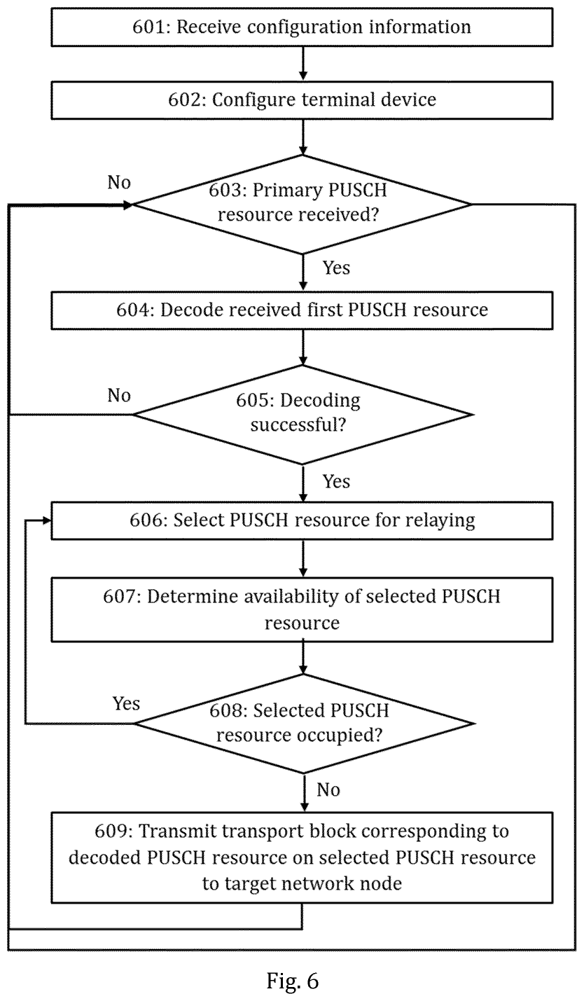

With the configuration information generated according to the definition described in the previous paragraph, the terminal devices associated with better link quality towards the target network node are configured to transmit the transport block before the terminal devices associated with worse link quality towards the target network node. This enables the terminal devices configured to transmit later detect whether the secondary CG PUSCH resource is already occupied (and the message of interest is already being repeated). This functionality is illustrated with FIG. 6 which shows an alternative process according to an embodiment carried out by a terminal device.

Referring to FIG. 6, blocks 601 to 605 may correspond to blocks 401 to 405 of FIG. 4 and will thus not be repeated here for brevity. However, it is assumed in this embodiment that according to the configuration information received in block 601 the terminal device in question does not have the earliest starting position (i.e., the highest link quality) of the one or more terminal device selected for relaying and will therefore perform steps 606 to 609. Further, it is assumed that the configuration information defines for the terminal device two or more secondary (CG) PUSCH resources which the terminal device may employ in the relaying. The terminal device having the earliest starting position may be configured to perform a process as described in relation to FIG. 4. In the case of a licensed carrier, only a single secondary (CG) PUSCH resource may be defined in the configuration information for the terminal device having the earliest starting position. When an unlicensed band is employed, multiple secondary (CG) PUSCH resources may be defined in the configuration information even for the terminal device having the earliest starting position to ensure successful relaying.

After the primary PUSCH resource has been decoded successfully in block 605, the terminal device selects, in block 606, a secondary (CG) PUSCH resource based on its configuration to be used for transmission. However, before the transmission the terminal device determines, in block 607, whether the selected secondary (CG) PUSCH resource is already occupied. The determining in block 607 may be based on a Listen-Before-Talk, LBT, procedure or a sequence detection procedure. In response to the selected secondary (CG) PUSCH resource being available (i.e., not occupied) in block 608, the terminal device causes transmitting, in block 609, a transport block corresponding to the decoded primary PUSCH resource on the selected secondary (CG) PUSCH resource to the target network node (i.e., a terminal device or the access node as defined in the configuration information) starting at the configured starting position. If the selected secondary (CG) PUSCH resource is occupied in block 608, the terminal device selects, in block 606, another (alternative) secondary (CG) PUSCH resource for relaying and determines whether said alternative secondary (CG) PUSCH resource is occupied in block 607, 608. Actions pertaining to blocks 606, 607, 608 are repeated until an available secondary (CG) PUSCH resource is found in block 608. Then, the terminal device causes transmitting, in block 609, a transport block corresponding to the decoded primary PUSCH resource on the selected alternative secondary (CG) PUSCH resource to the target network node starting at the configured starting position. If none of the configured secondary (CG) PUSCH resources is determined to be available in blocks 606 to 608, terminal device drops the decoded first (CG) PUSCH and moves back to receiving the next primary PUSCH resource in block 603.

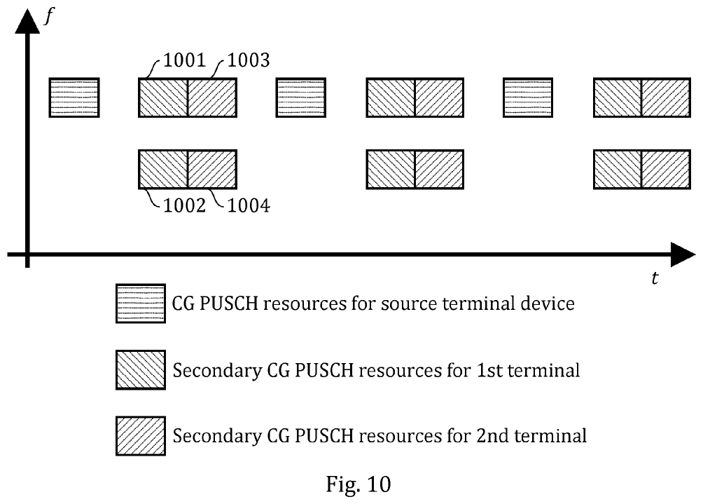

In some alternative embodiments, the access node may allocate different parallel secondary PUSCH resources for different relay paths (i.e., for different relaying terminal devices) to guarantee the reception of the transport block over multiple relaying link paths. In such embodiments, the terminal devices may or may not be configured to check, in blocks 607, 608, whether the particular PUSCH resource to be used for transmission is occupied. This functionality is discussed in more detail in relation to FIG. 10.

As described in relation to FIG. 6, the terminal devices with a later starting position may be configured by the access node to detect whether the secondary PUSCH resource is already occupied by another terminal device with an earlier starting position. This functionality may be achieved either using LBT or sequence detection.

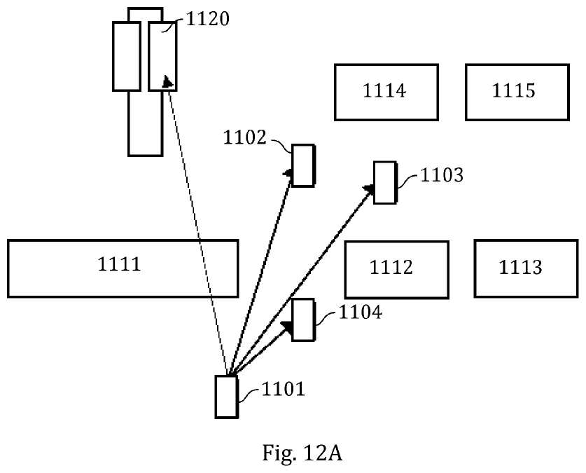

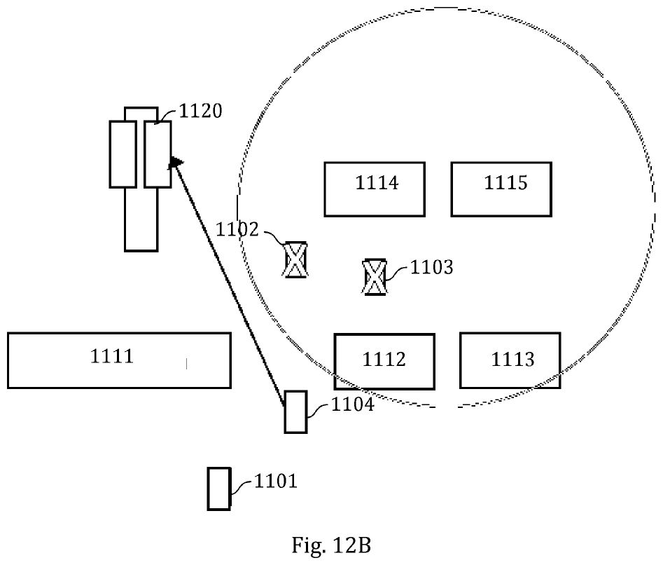

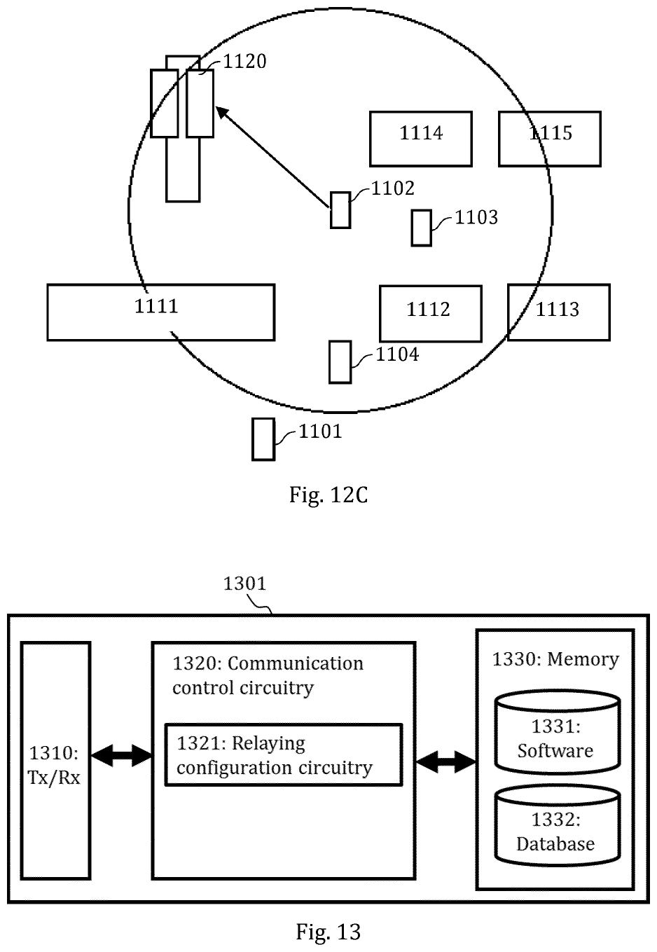

The LBT approach may follow the corresponding AUL procedure as discussed above, adapted to the used subcarrier spacing (SCS). For example, supporting three starting position may take 1-2 symbols for 30 or 60 kHz SCS. However, LBT approach prevents that other signals (e.g., scheduled PUSCH) are frequency-division-multiplexed with the configured grant PUSCH resources. The LBT has the disadvantage of being able to be blocked simply by interference (as required on unlicensed band, but not on licensed band), as will be discussed in relation to FIGS. 12A, 12B and 12C.

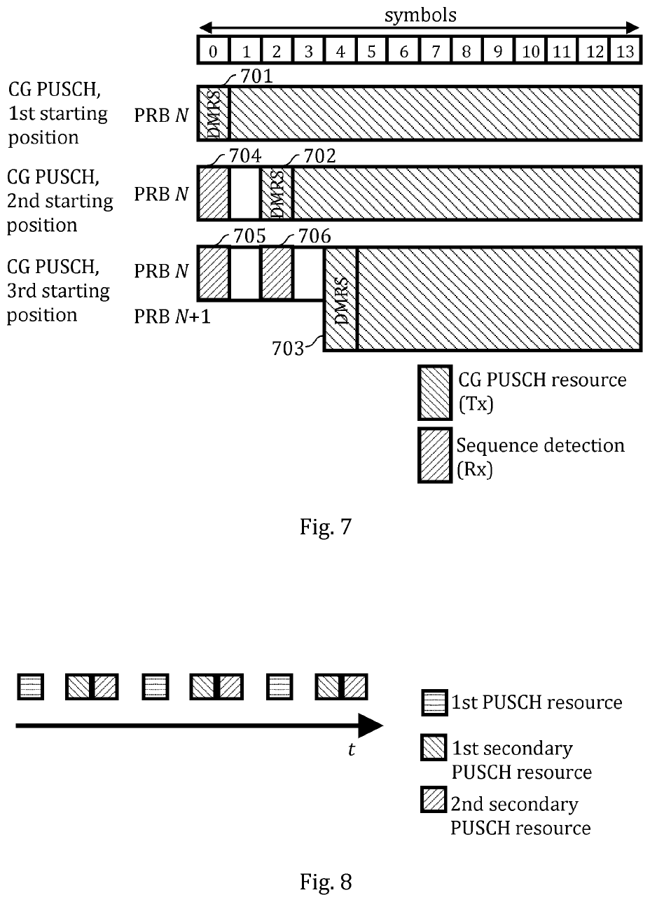

FIG. 7 illustrates an example of the sequence detection according to an embodiment. The sequence detection enables other signals to be frequency-division-multiplexed with the CG PUSCH resources, and it is also able to differentiate between transmissions from other relaying/repeating terminal devices and interference. In FIG. 7, the sequence detection and relaying procedure is shown for three earliest starting positions corresponding to three different terminal devices configured by the access node. The illustrated procedure corresponds to blocks 606 to 609 of FIG. 6. In FIG. 7, it is assumed that the decoding (in block 605) was successful for each of three terminal devices. The relaying terminal devices (or at least some of them) may be configured to perform the sequence detection procedure with the transmitted configuration information. As is evident from FIG. 7 and following paragraphs, the sequence detection procedure may be defined uniquely for each terminal device depending on the starting position defined for the terminal device in question.

For a first terminal device with the first starting position, no detection has to be performed as no terminal device is configured to transmit before said first terminal device. Therefore, all the symbols of the corresponding PRB may be used for transmitting the transport block on the secondary CG PUSCH resource assuming that the decoding of the primary CG PUSCH resource transmitted by the source terminal device was successful. The symbols may be, e.g., CP-OFDM or DFT-S-OFDM symbols. The transmission of the secondary CG PUSCH resource starts with a transmission of a front-loaded DMRS 701 to be used for sequence detection by the terminal devices with later starting positions, as well as for channel estimation by the target network node.

Before transmission, the second terminal device with the second starting position needs to determine whether the first terminal device is already transmitting with the secondary CG PUSCH resource (i.e., the secondary CG PUSCH resource with the first starting position). To achieve this, the second terminal device is configured by the access node to detect a pre-defined DMRS sequence (defined, e.g., by a root sequence, length and/or cyclic shifts) during a pre-defined sequence detection phase 704 associated with the starting position. Specifically, the sequence detection phase of the second terminal device is configured to be aligned with the DMRS transmission 701 for the first terminal device. The sequence detection phase may be, for example, based on comparing a metric indicating the sequence detection energy/accuracy/quality to a pre-defined and/or preconfigured threshold. If the pre-defined threshold is exceeded, the second terminal device considers the secondary CG PUSCH resource occupied and thus needs to transmit the transport block on an alternative secondary CG PUSCH resource. Otherwise, the second terminal device considers the secondary CG PUSCH resource unoccupied (i.e., available) and consequently the second terminal device may proceed with transmitting the transport block on the secondary CG PUSCH. In either case, the transmission of the secondary CG PUSCH resource in question starts also here with a transmission of a front-loaded DMRS 702 at the second starting position.

The sequence detection procedure for the third terminal device corresponding to the third starting position is in many ways similar to the sequence detection procedure for the second terminal device though slightly more complicated. The third terminal device is configured to detect, in symbol 705, whether the secondary PUSCH resource is occupied in a symbol aligned with the DMRS transmission of the first terminal device, similar to as discussed above for the second terminal device. In the case that the secondary PUSCH resource with the first starting position is deemed unoccupied, the third terminal device is configured to detect, in symbol 706, whether the secondary PUSCH resource with the second starting position is occupied in a symbol aligned with the DMRS transmission of the second terminal device. The second sequence detection phase may be carried out in a similar manner to the first sequence detection phase. Here, it is assumed that the secondary PUSCH resources with both the first and the second starting positions are unoccupied, Thus, after the first and second sequence detection phases showing the secondary PUSCH resource to be unoccupied the third terminal device causes transmitting the transport block on a secondary CG PUSCH resource with the third starting position. The transmission of the secondary CG PUSCH resource in question starts at the third starting position with a transmission of a front-loaded DMRS 703. In FIG. 7, the PRB allocation for the third terminal device is configured to be wider than for the terminal device with earlier starting positions to compensate for the shorter transmission interval compared to the first and second starting positions and possibly also for the worse link quality to the target network node.

As illustrated in FIG. 7, the terminal devices may be configured by the access node to leave one or more empty symbols between the subsequent sequence detection phases and between a sequence detection phase and the transmission of the DMRS. These symbols may be used by terminal device for sequence detection processing and switching from sequence detection to transmission.

In some embodiments, short mini-slots (with less than 14 symbols) may be used instead of the 14-symbol slots as shown in FIG. 7. For example, the duration of CG PUSCH mini-slot may be, e.g., 7 symbols. In such embodiments, the duration of the CG PUSCH transmission for the terminal devices with later starting positions may not necessarily need to be shortened (due to the slot boundary) as illustrated in FIG. 7.

FIGS. 8, 9 and 10 illustrate exemplary arrangements for the primary PUSCH resource containing the transmission from the source terminal device and secondary PUSCH resources reserved for the relaying/repeating transmissions for a first and a second terminal device. In said Figures, PUSCH resources only within the uplink portion are shown. The uplink and downlink portions may be alternating or the access node may override PUSCH resources with downlink resource allocation or Frequency Division Duplexing (FDD) may be used. The PUSCH resources may be PRBs in a 14-symbol slot or in a mini-slot (with less than 14 symbols). In FIGS. 8, 9 and 10, the axis labeled “t” indicates time and in FIG. 10 the axis labeled “f” indicates frequency.

FIG. 8 illustrates a simple arrangement where the allocated secondary PUSCH resources (namely, a first secondary PUSCH resource allocated for a first terminal device and a second secondary PUSCH resource allocated for a second terminal device) are sequential and non-overlapping. The first and second terminal devices are configured to use different starting positions to avoid overlapping or collisions. In the illustrated scenario, the first and second terminal devices may be configured by the access node with multiple different secondary CG PUSCH resources with different time offsets. The second terminal device configured with the second starting position may detect the first secondary CG PUSCH resource to be occupied as described in relation to FIG. 7 and consequently select the second secondary PUSCH resource for transmission as described in relation to FIG. 6.

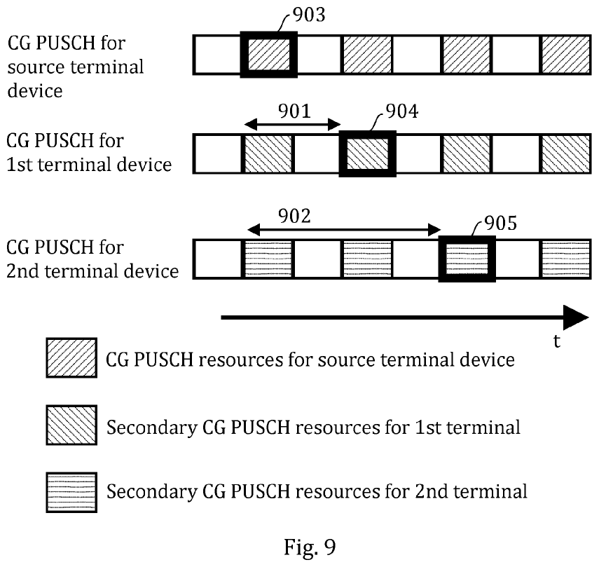

In FIG. 9, CG PUSCH resources with short periodicity are allocated for the first and secondary CG PUSCH resources. Short periodicity may be used to reduce latency. Similar to as described in relation to FIG. 5, there is one-to-one mapping between original transmission by the source terminal device and repeated (or relayed) transmissions by means of a pre-defined time offset. Two pre-defined time offsets are configured for the first and second terminal devices as is shown with elements 901, 902. The elements 903, 904, 905 shown with thicker outlines correspond to a particular transport block transmitted on the primary CG PUSCH resource and two different secondary CG PUSCH resources with the pre-defined time offset 901, 902. The source terminal transmits on element 903. The first terminal device configured with the first starting position transmits on element 904 corresponding to the pre-defined time offset 901. The second terminal device configured with the second starting position selects the earliest available resource, namely also the secondary CG PUSCH resource, on element 904, corresponding to the time offset 901 but detects the resource to be occupied. The second terminal device, then, selects the next available the secondary CG PUSCH resource on element 905, corresponding to the time offset 902, detects the resource to be unoccupied and transmits on element 905 the transport block detected on element 903. The pre-defined time offset allows the access node to combine original transmission and repeated transmission. If the original transmission (the primary PUSCH resource) and repeated transmissions use different PRBs, there is no risk that already relayed information is accidentally relayed again (even if the same RNTI is used both on original and repeated transmission).

In some embodiments, the access node may configure at least two of the one or more terminal devices with the configuration information to perform the transmitting using two or more secondary PUSCH resources parallel in frequency. This functionality is illustrated in FIG. 10. In FIG. 10, different PRBs have been allocated for different hopping-link paths (i.e., different relaying terminal devices) to guarantee the reception of the transport block over multiple relaying link paths. Parallel PRBs are allocated with first starting position for terminal devices with the best and 2nd best link quality towards the target network node. The same PRBs are allocated with the second starting position for the terminal devices with the 3rd best and the 4th best link quality towards the target network node (e.g., elements 1003, 1004, respectively), but with a later PUSCH starting position than the terminal devices with the best and 2nd best link quality. Correspondingly, terminal devices with the best and 2nd best link quality towards the target network node may transmit on elements 1001, 1002, respectively. Terminal devices with the 3rd best and the 4th best link quality towards the target network node and configured with second starting position may detect elements 1001, 1002, respectively, to be occupied and transmit on second secondary PUSCH resources, e.g., elements 1003, 1004, respectively.

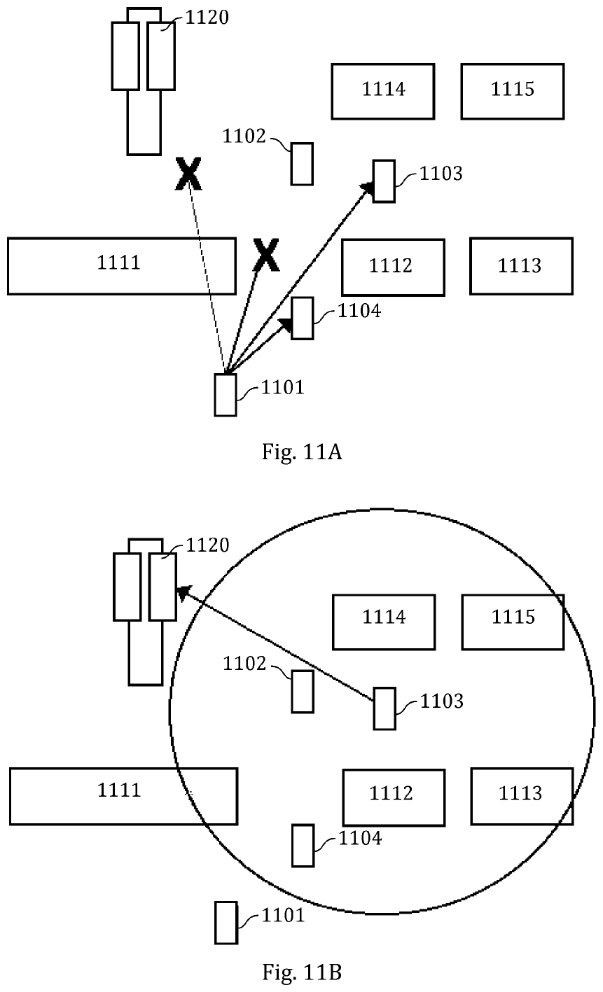

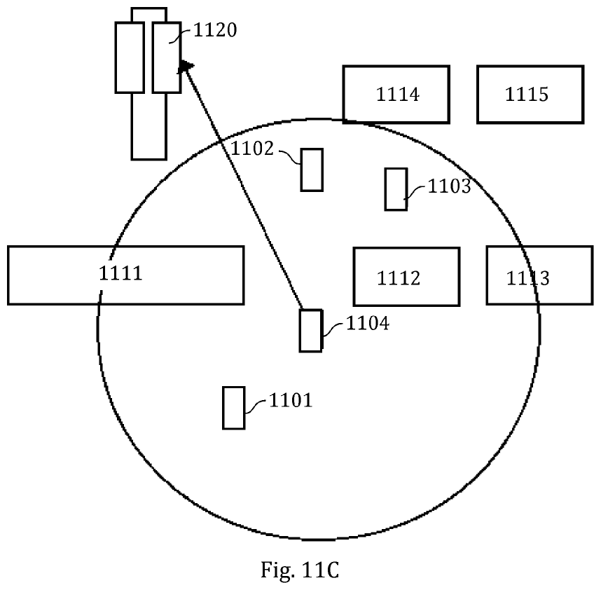

FIGS. 11A, 11B and 11C illustrate the operation of the proposed solution according to embodiments in an exemplary radio propagation environment. The radio propagation environment is similar to the one illustrated in FIG. 2 though with a different arrangement of access nodes 1120, terminal devices 1101, 1102, 1103, 1104 and obstacles 1111, 1112, 1113, 1114, 1115. In said Figures, it is assumed that the terminal device 1101 is a source terminal device and the terminal devices 1102, 1103, 1104 are terminal devices providing the best, 2^{nd} best and 3^{rd} best link quality to the access node 1120 and thus corresponding to first, second and third starting positions, respectively.

In FIG. 11A, the source terminal device 1101 causes transmitting a transport block on a primary PUSCH resource. Both the access node 1120 and the terminal device 1102 fail to detect the transmission. While the terminal device 1102 is not able to repeat the transmission (and thus does not reserve a secondary PUSCH resource), the terminal devices 1103, 1104 repeat the transmission on different secondary PUSCH resources using second and third starting positions as shown in FIGS. 11B and 11C, respectively.

FIGS. 12A, 12B and 12C illustrate the operation of the proposed solution according to an alternative embodiment in the exemplary radio propagation environment discussed also in relation to FIGS. 11A, 11B and 11C. Also in FIGS. 12A, 12B and 12C, it is assumed that the terminal device 1101 is a source terminal device and the terminal devices 1102, 1103, 1104 are terminal devices providing the best, 2^{nd} best and 3^{rd} best link quality to the access node 1120 and thus corresponding to first, second and third starting positions, respectively. In contrast to FIGS. 11A, 11B and 11C, FIGS. 12A, 12B and 12C illustrate the operation specifically when the terminal devices 1102, 1103, 1104 are configured to operate on an unlicensed band using energy-based LBT.

FIG. 12A illustrates an initial communication scenario where all of the three terminal devices 1102, 1103, 1104 are able to provide a relaying link from the source terminal device 1101 to the access node 1120. In FIG. 12B illustrating a time instance corresponding to a beginning of the transmission of the (earliest) secondary PUSCH resource, nearby interference (denoted by a circle in FIG. 12B) blocks relaying from the terminal devices 1102, 1103. However, LBT procedure carried out by the terminal device 1104 indicates a vacant channel and thus the terminal device 1104 repeats the transmission from the source terminal device on the secondary PUSCH resource. Thereafter when nearby interference has ended, the terminal device 1102 (with the first starting position) causes transmitting the transport block on a later secondary PUSCH resource, as illustrated in FIG. 12C.

In some embodiments (especially in embodiments not based on URLLC), multiple terminal devices (source terminal devices or repeating or relaying terminal devices) may be configured with the same CG PUSCH resources and consequently collisions may occur. Depending on physical locations of the colliding terminal devices relative to each other and relative to a receiver, the collision may or may not result in a failure of the decoding for a particular receiver (i.e., a repeating terminal device or an access node). Therefore, a repeating terminal device may, in some cases, be able to correctly decode the transport block from the source terminal device even if the decoding fails at the target network node (i.e., an access node or another repeating terminal device). To avoid repeated collisions also on the 2nd hop repetitions, the access node may configure overbooking of the CG PUSCH resources so that colliding source terminal devices do not have 2nd hop associated CG PUSCH resources (i.e., secondary CG PUSCH resources) colliding. Instead, the transport blocks potentially colliding on the 2nd hop CG PUSCH resources would originate from source terminal devices not using overlapping (primary) CG PUSCH resources for transmission.

In some embodiments, an uplink channel other than the PUSCH may be employed. In other words, the (CG) PUSCH resources (primary and/or secondary) as used in relation to any embodiments may be (physical) uplink resources of a (physical) uplink channel other than the PUSCH. Said (physical) uplink resources may have any properties discussed in relation to (CG) PUSCH resources.

The proposed solutions according to embodiments discussed above provide multiple advantages over prior art. The embodiments provide a simple solution for achieving diversity against large-scale fading. In the proposed solution, a larger number of terminal devices may be configured to detect the transmission from the source terminal device than there are 2nd hop resources which improves resource efficiency. The 2nd hop may be transmitted by a pre-defined number of terminal devices (which decoded the 1st hop successfully), in the order of 2nd hop link qualities. Moreover, the proposed solution is to a large extent built on top of existing or upcoming NR functionalities meaning that it may be implemented easily.

In some embodiments, the actions performed by the access node (i.e., a network node or network element providing wireless access) according to any embodiments as described above may be performed fully or partly by another network node or network element or even by multiple network nodes/elements. For example, said actions (or at least some of said actions) may be performed, instead of the access node, by a core element or by an edge cloud (element).

The blocks, related functions, and information exchanges described above by means of FIGS. 3 to 10, 11A, 11B, 11C, 12A, 12B and 12C are in no absolute chronological order, and some of them may be performed simultaneously or in an order differing from the given one. Other functions can also be executed between them or within them, and other information may be sent, and/or other rules applied. Some of the blocks or part of the blocks or one or more pieces of information can also be left out or replaced by a corresponding block or part of the block or one or more pieces of information.

The techniques and methods described herein may be implemented by various means so that an apparatus/device configured to support relaying based on at least partly on what is disclosed above with any of FIGS. 1 to 10, 11A, 11B, 11C, 12A, 12B and 12C, including implementing one or more functions/operations of a corresponding terminal device or access node (or network element) described above with an embodiment/example, for example by means of any of FIGS. 3 to 10, 11A, 11B, 11C, 12A, 12B and 12C, comprises not only prior art means, but also means for implementing the one or more functions/operations of a corresponding functionality described with an embodiment, for example by means of any of FIGS. 3 to 10, 11A, 11B, 11C, 12A, 12B and 12C. Further, the implementation may comprise separate means for each separate function/operation, or means may be configured to perform two or more functions/operations.

For example, one or more of the means described above may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, logic gates, decoder circuitries, encoder circuitries, other electronic units designed to perform the functions described herein by means of FIGS. 1 to 10, 11A, 11B, 11C, 12A, 12B and 12C, or a combination thereof. For firmware or software, the implementation can be carried out through modules of at least one chipset (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components described herein may be rearranged and/or complemented by additional components in order to facilitate the achievements of the various aspects, etc., described with regard thereto, and they are not limited to the precise configurations set forth in the given figures, as will be appreciated by one skilled in the art.

FIG. 13 provides an access node or other network node or network element (apparatus, device) according to some embodiments. FIG. 13 illustrates an access node or other network element (in the following, simply “the access node” for brevity) configured to carry out at least the functions described above in connection with configuring relaying using one or more terminal devices. Each access node may comprise one or more communication control circuitry 1320, such as at least one processor, and at least one memory 1330, including one or more algorithms 1331, such as a computer program code (software) wherein the at least one memory and the computer program code (software) are configured, with the at least one processor, to cause the access node to carry out any one of the exemplified functionalities of the access node described above.

Referring to FIG. 13, the communication control circuitry 1320 of the access node 1301 comprise at least relaying configuration circuitry 1321 which is configured to configure one or more terminal devices for performing relaying. To this end, the relaying configuration circuitry 1321 is configured to carry out functionalities described above by means of any of FIGS. 3 and 5 using one or more individual circuitries. The relaying configuration circuitry 1321 may also be configured to configure the one or more terminal devices so as to carry out, using the one or more terminal devices, functionalities described above by means of any of FIGS. 4, 6 to 10, 11A, 11B, 11C, 12A, 12B and 12C using the one or more individual circuitries.

Referring to FIG. 13, the memory 1330 may be implemented using any suitable data storage technology, such as semiconductor based memory devices, flash memory, magnetic memory devices and systems, optical memory devices and systems, fixed memory and removable memory.

Referring to FIG. 13, the access node may further comprise different interfaces 1310 such as one or more communication interfaces (TX/RX) comprising hardware and/or software for realizing communication connectivity over the medium according to one or more communication protocols. The communication interface may provide the access node with communication capabilities to communicate in the cellular communication system and enable communication between user devices (terminal devices) and different network nodes or elements and/or a communication interface to enable communication between different network nodes or elements, for example. The communication interface may comprise standard well-known components such as an amplifier, filter, frequency-converter, (de)modulator, and encoder/decoder circuitries, controlled by the corresponding controlling units, and one or more antennas. The communication interfaces comprise radio interface components providing the access node radio communication capability to provide a cell with at least an unlicensed band. The communication interfaces may comprise optical interface components providing the base station with optical fiber communication capability.

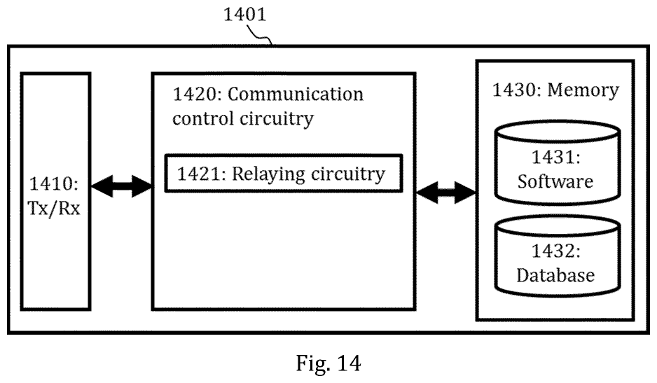

FIG. 14 provides a terminal device (apparatus, equipment, UE) according to some embodiments. FIG. 14 illustrates a terminal device configured to carry out at least the functions described above in connection with information sharing. Each terminal device may comprise one or more communication control circuitry 1420, such as at least one processor, and at least one memory 1430, including one or more algorithms 1431, such as a computer program code (software) wherein the at least one memory and the computer program code (software) are configured, with the at least one processor, to cause the terminal device to carry out any one of the exemplified functionalities of the terminal device described above.

Referring to FIG. 14, the communication control circuitry 1420 of the terminal device 1401 comprise at least relaying circuitry 1421 which is configured to perform relaying. To this end, the relaying circuitry 1421 is configured to carry out functionalities described above by means of any of FIGS. 4, 6 to 10, 11A, 11B, 11C, 12A, 12B and 12C using one or more individual circuitries.

Referring to FIG. 14, the memory 1430 may be implemented using any suitable data storage technology, such as semiconductor based memory devices, flash memory, magnetic memory devices and systems, optical memory devices and systems, fixed memory and removable memory.

Referring to FIG. 14, the terminal device may further comprise different interfaces 1410 such as two or more communication interfaces (TX/RX) comprising hardware and/or software for realizing communication connectivity over the medium according to one or more communication protocols. The communication interface may provide the terminal device with communication capabilities to communicate in the cellular communication system and enable communication between terminal devices and different network nodes or elements, for example. The communication interface may comprise standard well-known components such as an amplifier, filter, frequency-converter, (de)modulator, and encoder/decoder circuitries, controlled by the corresponding controlling units, and one or more antennas. The communication interfaces comprise radio interface components providing the terminal device radio communication capability to use CG PUSCH resources and/or unlicensed bands. The terminal device may also comprise different user interfaces.

As used in this application, the term ‘circuitry’ may refer to one or more or all of the following: (a) hardware-only circuit implementations, such as implementations in only analog and/or digital circuitry, and (b) combinations of hardware circuits and software (and/or firmware), such as (as applicable): (i) a combination of analog and/or digital hardware circuit(s) with software/firmware and (ii) any portions of hardware processor(s) with software, including digital signal processor(s), software, and memory(ies) that work together to cause an apparatus, such as a terminal device or an access node, to perform various functions, and (c) hardware circuit(s) and processor(s), such as a microprocessor(s) or a portion of a microprocessor(s), that requires software (e.g. firmware) for operation, but the software may not be present when it is not needed for operation. This definition of ‘circuitry’ applies to all uses of this term in this application, including any claims. As a further example, as used in this application, the term ‘circuitry’ also covers an implementation of merely a hardware circuit or processor (or multiple processors) or a portion of a hardware circuit or processor and its (or their) accompanying software and/or firmware. The term ‘circuitry’ also covers, for example and if applicable to the particular claim element, a baseband integrated circuit for an access node or a terminal device or other computing or network device. In embodiments, the at least one processor, the memory, and the computer program code form processing means or comprises one or more computer program code portions for carrying out one or more operations according to any one of the embodiments of FIGS. 3 to 10, 11A, 11B, 11C, 12A, 12B and 13C or operations thereof.

Embodiments as described may also be carried out in the form of a computer process defined by a computer program or portions thereof. Embodiments of the methods described in connection with FIGS. 3 to 10, 11A, 11B, 11C, 12A, 12B and 12C may be carried out by executing at least one portion of a computer program comprising corresponding instructions. The computer program may be provided as a computer readable medium comprising program instructions stored thereon or as a non-transitory computer readable medium comprising program instructions stored thereon. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium. Coding of software for carrying out the embodiments as shown and described is well within the scope of a person of ordinary skill in the art.

Even though the invention has been described above with reference to examples according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. An access node comprising:
at least one processor; and
at least one non-transitory memory including computer program code;
the at least one memory and the computer program code configured, with the at least one processor, to cause the access node at least to perform:
selecting one or more terminal devices connected to the access node for relaying a signal from the source terminal device to the access node based at least on radio link measurements;
configuring, by generating configuration information and causing transmitting the configuration information, each of the one or more terminal devices to decode each received primary uplink resource, and
if the decoding is successful, causing transmitting a transport block corresponding to the decoded primary uplink resource on a secondary uplink re-source using a pre-defined starting position to a target network node, wherein the target network node is the access node or one of the one or more terminal devices, at least one terminal device being configured by the access node to use the access node as the target network node; and
receiving at least one transport block transmitted from the source terminal device via one or more terminal devices of the one or more terminal devices on one or more secondary uplink resources.

2. An access node of claim 1, wherein the at least one memory and the computer program code are configured, with the at least one processor, to cause the access node to perform the selecting in response to failing to detect a signal from a source terminal device and/or the source terminal device being configured for transmission with low latency and high or ultra-high reliability.

3. The access node of claim 1, wherein the at least one memory and the computer program code are configured, with the at least one processor, to cause the access node further to perform the radio link measurements before the selecting by:
causing performing discovery on one or more terminal devices;
causing performing radio link measurements between terminal devices using one or more discovered terminal devices;
receiving measurement results from the discovered one or more terminal devices;
causing transmitting to the one or more discovered terminal devices a request for transmitting a reference signal to the access node; and
detecting and measuring one or more reference signals transmitted from the one or more discovered terminal devices.

4. The access node of claim 1, wherein the at least one memory and the computer program code are configured, with the at least one processor, to cause the access node further to perform:
configuring each of the one or more terminal devices using the configuration information to perform the decoding based on a first radio network temporary identifier, used by the source terminal device and comprised in the configuration information and to perform the transmitting using the first radio network temporary identifier or a second radio network temporary identifier comprised in the configuration information.

5. The access node of claim 1, wherein the at least one memory and the computer program code are configured, with the at least one processor, to cause the access node further to perform:
configuring the source terminal device, by causing transmitting configuration information comprising at least a first radio network temporary identifier to the source terminal device, to use the first radio network temporary identifier for transmitting on the primary uplink resource, the first radio network temporary identifier being used by the source terminal device only for transmissions on primary uplink resources.

6. (canceled)

7. (canceled)

8. The access node of claim 1, wherein the pre-defined starting position is assigned for each terminal device based on the radio link measurements so that the pre-defined starting position is defined via a mono-tonically decreasing function of the pre-defined metric indicating link quality or is based on the order of values of the pre-defined metric indicating link quality for the one or more terminal devices so that the highest value of the pre-defined metric corresponds to a first starting position and the lowest value of the pre-defined metric corresponds to a last starting position.

9. The access node of claim 1, wherein the at least one memory and the computer program code are configured, with the at least one processor, to cause the access node further to perform:
configuring with the configuration information any terminal devices with a pre-defined starting position later than the earliest pre-defined starting position assigned for the one or more terminal devices to
detect, before the transmitting, whether the secondary uplink resource to be used for the transmitting is already occupied based on a listen before talk procedure or a sequence detection procedure,
perform the transmitting on the secondary uplink resource only in response to a secondary physical uplink shared channel resource not being occupied and
transmit, in response to the secondary uplink resource being occupied, the transport block corresponding to the decoded primary uplink resource on another secondary physical uplink shared channel resource determined not to be occupied to the target network node.

10. The access node of claim 9, wherein the at least one memory and the computer program code are configured, with the at least one processor, to cause the access node further to perform:
configuring with the configuration information any terminal devices with the pre-defined starting position later than the earliest pre-defined starting position assigned for the one or more terminal devices to
in response to the secondary uplink resource being occupied, detect, before the transmitting on the another secondary uplink resource, whether one or more secondary uplink resources, configured to be used for transmitting of the transport block if the secondary uplink resource is occupied, are already occupied based on the listen before talk procedure or the sequence detection procedure.

11. The access node of claim 9, wherein if the sequence detection procedure is used in the detecting, the at least one memory and the computer program code are configured, with the at least one processor, to cause the access node further to perform:
configuring, with the configuration information, each of the one or more terminal devices to transmit a front-loaded demodulation reference signal on a secondary uplink resource used for transmitting of the transport block to enable sequence detection by other terminal devices of the one or more terminal devices; and
configuring with the configuration information each terminal device with the pre-defined starting position later than the earliest pre-defined starting position assigned for the one or more terminal devices to perform the detecting based on the sequence detection procedure so as to detect any front-loaded demodulation reference signals transmitted by other terminal devices of the one or more terminal devices.

12. The access node of claim 1, wherein the at least one memory and the computer program code are configured, with the at least one processor, to cause the access node further to perform:
configuring each of the one or more terminal devices with the configuration information to perform the decoding only for ultra-reliable low latency communication transmissions and/or for transmissions originating from the source terminal device based on the decoded primary uplink resources and/or a first radio network temporary identifier used in the decoding.

13. The access node of claim 1, wherein the configuration information comprises one or more of information on the primary uplink resources to be used in the decoding, information on the secondary uplink resources to be used in the transmitting, a modulation coding scheme and a physical resource block allocation, a first radio network temporary identifier used by the source terminal device and a second radio network temporary identifier to be used by the configured terminal device.

14. The access node of claim 1, wherein the at least one memory and the computer program code are configured, with the at least one processor, to cause the access node further to perform:
configuring at least two of the one or more terminal devices with the configuration information to perform the transmitting using two or more secondary uplink resources parallel in frequency.

15. A terminal device comprising:
at least one processor; and
at least one non-transitory memory including computer program code;
the at least one memory and the computer program code configured, with the at least one processor, to cause the terminal device at least to perform:
in response to receiving configuration information from an access node, configuring the terminal device based on the configuration information;
decoding any received primary uplink resources according to a configuration of the terminal device; and
in response to decoding of a primary uplink resource being successful, causing transmitting a transport block corresponding to the decoded primary uplink resource on a secondary uplink resource using a pre-defined starting position to a target network node according to the configuration, wherein the target network node is the access node or a terminal device.

16. (canceled)

17. (canceled)

18. The terminal device of claim 15, wherein the at least one memory and the computer program code are configured, with the at least one processor, to cause the terminal device further to perform according to the configuration of the terminal device:
detecting, before the transmitting, whether the secondary uplink resource to be used for the transmitting is already occupied based on a listen before talk procedure or a sequence detection procedure;
performing the transmitting on the secondary uplink resource only in response to the secondary uplink resource not being occupied; and
causing transmitting, in response to the secondary uplink resource being occupied, the transport block corresponding to the decoded primary uplink resource on another secondary uplink resource determined not to be occupied to the target network node.

19. The terminal device of claim 18, wherein the at least one memory and the computer program code are configured, with the at least one processor, to cause the terminal device further to perform according to the configuration of the terminal device before the transmitting on the another secondary resource:
in response to the secondary uplink resource being occupied, detecting whether one or more secondary uplink resources configured to be used for transmitting of the transport block are occupied based on the listen before talk procedure or the sequence detection procedure, wherein the another secondary resource is one of the one or more secondary uplink resources.

20. The terminal device of claim 18, wherein if the sequence detection procedure is used in the detecting, the at least one memory and the computer program code are configured, with the at least one processor, to cause the terminal device further to perform according to the configuration of the terminal device:
performing the detecting based on the sequence detection procedure so as to detect any front-loaded demodulation reference signal transmitted by one or more other terminal devices; and/or
causing transmitting a front-loaded demodulation reference signal on a secondary uplink resource used for transmitting of the transport block to enable sequence detection by other terminal devices.

21. The terminal device of claim 15, wherein the at least one memory and the computer program code are configured, with the at least one processor, to cause the terminal device further to perform the decoding according to the configuration only for ultra-reliable low latency communication transmissions and/or for transmissions originating from the source terminal device based on the decoded primary uplink resources and/or a first radio network temporary identifier used in the decoding.

22. The terminal device of claim 15, wherein the configuration information comprises one or more of information on the primary uplink resource to be used in the decoding, information on secondary uplink resources to be used in the transmitting, a modulation coding scheme and a physical resource block allocation, a first radio network temporary identifier used by the source terminal device and a second radio network temporary identifier to be used by the configured terminal device.

23. A method comprising:
selecting one or more terminal devices connected to an access node for relaying a signal from the source terminal device to the access node based at least on radio link measurements;
configuring, by generating configuration information and causing transmitting the configuration information, each of the one or more terminal devices to
decode each received primary uplink resource, and
if the decoding is successful, causing transmitting a transport block corresponding to the decoded primary uplink resource on a secondary uplink resource using a pre-defined starting position to a target network node, wherein the one or more terminal devices are configured by the access node to use different secondary uplink resources and different pre-defined starting positions and the target network node is the access node or one of the one or more terminal devices, at least one terminal device being configured by the access node to use the access node as the target network node; and
receiving at least one transport block transmitted from the source terminal device via one or more terminal devices of the one or more terminal devices on one or more secondary uplink resources.

24. A method comprising:
in response to receiving configuration information from an access node, configuring a terminal device based on the configuration information;
decoding any received primary uplink resources according to a configuration of the terminal device; and
in response to decoding of a primary uplink resource being successful, causing transmitting a transport block corresponding to the decoded primary uplink resource on a secondary uplink resource using a pre-defined starting position to a target network node according to the configuration, wherein the target network node is the access node or a terminal device.

25.-29. (canceled)
